(19) United States
(12) Patent Application Publication
(10) Pub. No.: US 2009/0023120 A1
(43) Pub. Date: Jan. 22, 2009

(54) PROGRAM TO INTENSIVELY TEACH A SECOND LANGUAGE USING ADVERTISEMENTS

(75) Inventors: Robert Goodman, Bodega Bay, CA (US); James J. Carniglia, Santa Rosa, CA (US)

Correspondence Address: Beyer Law Group LLP, P.O. BOX 1687, Cupertino, CA, 95015-1687, US

(73) Assignee: ASIA ESL, LLC, Bodega Bay, CA (US)

(21) Appl. No.: 12/184,024

(22) Filed: Jul. 31, 2008

Related U.S. Application Data
(63) Continuation of application No. PCT/US08/66436, filed on Jun. 10, 2008.
(60) Provisional application No. 60/943,065, filed on Jun. 10, 2007.

(51) Int. Cl. G09B 19/08

(52) U.S. Cl. 434/157

(57) ABSTRACT

An immersion method teaches a student conversational speech aspects of a language (such as a second language) while, in the process, intensively exposing the student to a relevant conversational program (such as advertising) as an integral part of the teaching process. The method may include displaying, to the user/student, portions of video and audio of a conversational program (such as an advertisement in a second language), while causing a textual indication of the displayed audio to be simultaneously displayed (e.g., in the second language and a native language). The user may be prompted for information indicative of comprehension of the program by the user. Particularly in the case of advertising, information indicative of comprehension of the program can be very useful to the advertiser, as well as the prompting process itself serving to reinforce themes presented in the advertisement.

### CROSS-REFERENCE TO RELATED APPLICATIONS

This application is a continuation of prior International Application No.: PCT/US08/66436, from which priority under 35 U.S.C. §120 and 35 U.S.C § 365(c) is claimed. International Application No.: PCT/US08/66436 claims priority under 35 USC 119(e) to United States Provisional Patent Application No. 60/943,065, filed Jun. 10, 2007. All of the above-listed applications are incorporated herein by reference for all purposes.

### BACKGROUND OF THE INVENTION

English is taught in public schools throughout Asia, and so the principles of syntax and grammar are readily available to students; however, understanding these formal aspects of the language is generally not sufficient to learn conversational English. Asian students do not have readily available the principles of conversational English. American English (Americanese) is still very challenging, foreign, and difficult to master. The situation is generally similar for anyone attempting to learn a second language.

The economics of advertising used to be predictable. In the past, a media buyer could look at a designated market, choose a television station, magazine, newspaper or radio station and know that for “x” cost per listener, predictable results would occur. Over the last decade, with the advent of digital media and the expansion of the internet, there is no longer a clear cut media choice for an advertiser to pick and feel that there is any security behind that decision. Today over 185 television channels exist; digital video recorders can be used to record broadcasts without advertisements and people of all ages are spending hours on their computers surfing. These elements seriously challenge even the most competent of media buyers to provide “the sure thing” for their advertising clients.

### SUMMARY OF THE INVENTION

In one aspect, an immersion method is provided to teach a student conversational speech aspects of a language (such as a second language to a user whose native language is not the second language) while, in the process, intensively exposing the student to a relevant conversational program (such as advertising) as an integral part of the teaching process. The student is highly motivated to intensely interact with the program and, in the case of advertising in particular, this provides great benefit to the advertiser as well.

For example, the method may include displaying, to the user/student, portions of video and audio of a conversational program (such as an advertisement in a second language), while causing a textual indication of the displayed audio to be simultaneously displayed (e.g., in the second language and a native language). The user's voice is recorded while the user is attempting to mimic the audio of the program displayed to the user. The audio of the program and the recording of user's voice are played, and the user may provide user input via a user interface to cause repeating of the displaying, recording and playing steps. The user may be provided with a score and/or suggestions regarding how well the user mimics the audio of the program. The user may be prompted for information indicative of comprehension of the program by the user. Particularly in the case of advertising, information indicative of comprehension of the program can be very useful to the advertiser, as well as the prompting process itself serving to reinforce themes presented in the advertisement.

Students may compete with each other regarding how well each can mimic the audio of the advertisement, even students who are not in the same physical location and even students who do not know each other. For each student, the mimicking is scored based on how close the user's voice is to the audio of the advertisement, and the students may compete, such as for best match.

### BRIEF DESCRIPTION OF THE DRAWINGS

FIG. 1 is a screenshot of an example “launching page” of a program to intensively teach a second language using advertisements.

FIG. 2 is a screenshot illustrating a page that may result from a user selecting an icon representing a computer category, from the FIG. 1 launching page.

FIG. 3 is a screenshot of a second language learning interface that is specific to a selected advertisement.

FIG. 4 is a flowchart illustrating how the program may prompt a user to record his/her own voice, mimicking the audio track of the portion.

FIG. 5 schematically illustrates an architecture in which an advertisement and corresponding meta-information may be streamed to a user for use in learning a second language.

FIGS. 6 and 7 are screen shots of a Flash editor program, which serves to illustrate the scene/object nature of program organization in one example.

FIG. 8 schematically illustrates how a first user and a second user may interact with the same SWF, such as for a competition between the first user and the second user.

### DETAILED DESCRIPTION OF ILLUSTRATIVE EMBODIMENTS

In accordance with an aspect, a system and method utilizes novel, stimulating, and fun approaches to make learning conversational English (e.g., including idiomatic and colloquial expression), easy and fun. The system may capture an audience's intensive attention to an advertisement such that, for example, a commercial spot presented using the system may have an average of one hour viewing, understanding and intensive interaction. The delivery format can make archaic the concept of gross rating points for pricing advertising space/time, as this exponentially profitable form of concentrated advertising motivates viewers to become intimate with each advertised service or product. While much of the discussion herein relates to intensive interaction with conversational advertising, the method has broader applicability to other types of conversational audio/video, examples of which are described herein as well. Furthermore, the method has broader applicability beyond teaching conversational English to non-native English speakers and, in fact, beyond teaching conversational aspects of any second language.

The system may fully teach the rhythm, pitch, timing and articulation not associated with current ESL or other “second language” programs, and may be provided free, yet still be extremely profitable for the provider. Between the students' success of language learning and the association to the products and services which have contributed to that success, there will be an enhanced dedicated consumerism established.

The system may be provided as a free program, to users, that is generally-accessible via a network such as the internet. The system helps students to learn the differences between phonetic speech and idiom in social contexts. It is based on the principle that conversational language is best developed through immersion and adaptation. Simultaneous video, audio and text scripts utilizing American voices train the eye and ear to subtleties and complexities. This brings real-time immersion to students, 24-hours-a-day, leading them to fluency at a rapid pace. Many students may now learn conversational English at no cost to themselves (while intensively interacting with advertising).

The service features, for example, broadcasts of American speakers chatting about various products using natural voice inflection and colloquial language. Students watch the verbal interaction and can read a script while listening, which helps them understand rhythm, timing, cadence and pitch. This interaction brings fun to the learning process. In addition, students can challenge each other through verbal interaction in various online games, contests and quizzes. Prizes are awarded based on ESL learning success.

Correct interpretation of Americanese text as spoken in these videos, corresponds to the language ability of each student. All can record and play back their own voices while reading scripts. This creates the external auditory feedback, which is superior to the traditional “bone conduction” method of self-reviewing speech patterns. Accent, pronunciation and word command may be successfully modified. This feedback process, akin to face-to-face tutoring, leads to eventual mastery of conversational English.

The program may include rewards for successful completion, in addition to the honor of mastering each section. Prizes may range from automobiles and trips to America, to jewelry and clothing emblazoned with commercial brand logos. Students will become more articulate, improve critical “Americanese” speaking and thinking skills, while absorbing commercial subject matter. Contests, competition and rewards are designed to promote the program to an ever-growing Asian population.

A strategic partner may help launch the program in eastern Asia and secure advertisers and support use of the program by providing scripted commercial content. The theatrical quality commercials may be, for example, sixty to one hundred twenty second spots featuring products or services. Actors will speak roles in English accompanied by English and appropriately translated scripted text (e.g., translated into the user's native language). The multi-sensory approaches to teaching language skills help students learn rhythm, timing, pitch and volume, all while developing a profound familiarity with the advertised product or service.

The program should produce considerable yield for advertisers. Commercials will be shown to tens of millions of upwardly mobile Asians viewing during hour-long sessions. Actors will chat about products and/or services such as cell phones, automobiles, bicycles, clothing, movies, appliances, cosmetics, toothbrushes and more. As a result, product knowledge will spread over Asia. Sought-after brands will reach captive, focused, customer bases like no other type of marketing has done before.

The economics of advertising used to be predictable, typically based on statistics. In the past, a media buyer could look at a designated market, choose a television station, magazine, newspaper or radio station and know that for “x” cost per listener, predictable results would occur. Over the last decade, with the advent of digital media and the expansion of the internet, there is no longer a clear cut media choice for an advertiser to pick and feel that there is any security behind that decision. Today over 185 television channels exist; digital video recorders can be used to record broadcasts without advertisements and people of all ages are spending hours on their computers surfing. These elements seriously challenge even the most competent of media buyers to provide “the sure thing” for their advertising clients.

The program may offer a unique advertising monopoly to a designated strategic partner. Its state-of-the-art methodology includes targeted commercial messaging to the most desirable demographic in Asia. The program will become the “cool” way to learn Americanese. It may be culturally “alive” through interactive immersion study sessions with others learning Americanese.

Advertisers may reap their own rewards. Continuous replay of commercial messages reinforces positive retention of the product and brand name. The novel approach to learning, along with its state-of-the-art social network feature, will make it the number one choice of ESL learners in Asia.

The program may be focused, for example, on 650+million Asian ESL students. It offers them a very inexpensive, more productive way to learn conversational English through immersion than Asian colleges, American and Canadian universities. Conventionally, there are numerous CD language courses, books, cassettes and web sites available. Most offer courses on a subscription basis. Some of them are Dave's ESL Cafe, International EFL Cafe, ESL-lab, TEFL-Via Lingua, ESL of Asia, Philippine Wintercamps ESL, Rosetta Stone, worldwidelearn.com, Savanna College of Art and Design and various correspondence courses. All support the billion dollar ESL growth industry. Costs for these courses range from no initial outlay to thousands of dollars per student. Although there is some success, few of the noted sites are popular and effective.

The program may be promoted to advertisers by a partner, such as an international advertising agency or agencies handling product placement and advertisements throughout Asia. Over 10,000,000 students at any given time will be reading and verbalizing advertising copy accompanying each product or service script. Similar to “infomercials,” scripts may be designed to standards consistent with the program. The circular relationship between the strategic partner and the provider of the program may be highly profitable.

There may be various different commercials (learning plans) available to students each night. Advertisers may elect to use the same material on different nights. Each spot will gain tremendous exposure in the enormous Asian demographic.

In one example, advertiser cost for commercial placement in the program is as little as $.015 per night per member. There may be an additional $.12 cents per hit for each student who watches the commercial. These costs are below par with most Internet advertising. The difference, as noted, is the astounding result of having a one-hour, focused customer base concentrating on a selected commercial. An unprecedented viewing audience is both created and served.

An example illustrates typical advertiser cost. Of one million Korean students utilizing the program, if only 20% choose a particular commercial to study, the cost to the advertising agency may be an initial $15,000 placement fee, plus $24,000 for viewer exposure. This is a phenomenally low expense for such intense brand exposure and penetration.

The program may be licensed (even at no cost) to existing schools throughout Asia. Each school will be able to have their students use the novel programming with their instructors to enhance the student success thereby eliminating competition with us. AsiaEs1 provides curriculum guides to help each school maximize their student's results. Their students will enjoy all the benefits of the program, both in the classroom as well as privately.

New member signup may be based on offering free memberships to students throughout Asia, including free use of the web site for instructional classroom guidelines. These no-cost features will be compelling in the Asian ESL market. As with myspace.com with its 10,000,000+users, free web site use can be a key attractor. Overwhelming demand for ESL throughout Asia coupled with the Internet socializing feature Asia Es1 offers portends a membership base in the tens of millions. Growth is based on free access, unequalled user-friendly technology, fun, audio/visual/text programming, prizes, rewards and socialization. Aggressive advertising and promotional budgets are implemented. Advertising placement fees may be set at US$.015 per member for each 60-120 second commercial every 24 hours; 75% of total free members viewing commercials nightly; an additional charge of US$.12 cents per commercial showing, and with six different commercial presentations nightly for a total of 180 per month.

The purveyor of the program may manage its global reach with a small, precise group. Although there will be millions of subscribers, the design is based on a small audience platform. Consumer transactions may be outsourced with a detailed management plan enabling several companies to serve our audience, while meeting their own business need. Servicing different countries with separate languages is a science in design, lending itself to syndication of product and services with specific language changes.

The strategic partner responsibility may be to serve clients' best interests while satisfying requirements of the program. Both are mutually compatible. It is in the best interest of strategic partners to build a following in each country so that media placement meets the needs of the partners' advertising clients. Contests and awards are operated by these strategic partners under control of the program owner and fully exploit the products and services being promoted by serving as rewards.

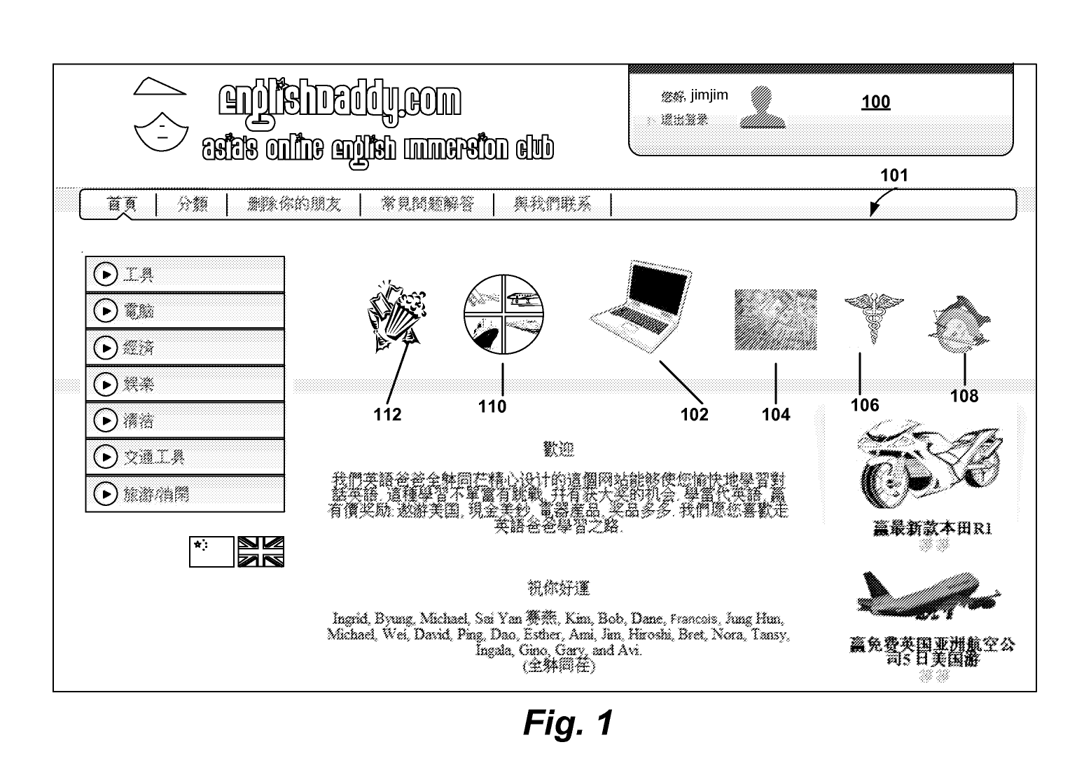

We now describe one example user interface presented by a language-learning program such as the program discussed above. Referring to FIG. 1, an example “launching page” 100 is illustrated. (The launching page 100 may be provided, for example, based on data, such as a Flash SWF file, from a server via a network such as the internet. Examples of this will be described later.) As shown in FIG. 1, the launching page 100 includes a pictorial menu 101 from which a user may choose a category of interest. The category of interest pertains, for example, to a category for which advertising may be provided in connection with conversational instruction in a second language. (Though many of the examples pertain to advertising, the program may present other types of conversational audio/video, particularly those that are useful to learn. For example, the conversations may be call-center scripts, sales presentations, or other programming that can be useful for learning, including for learning conversational aspects of a language.) In the FIG. 1 example, the pictorial menu 101 includes icons representing a computer category 102, a finance category 104, a medical category 106, an appliances/tools category 108, a travel category 110 and a fast food category 112. These are examples, and the categories may be different. The categories may be based, for example, on available advertising, local interests, etc. The pictorial menu 101 may be, for example, a circular menu such that additional choices can be provided “from behind” and brought to the front where such choices are available for selection, though various types of menus may be provided.

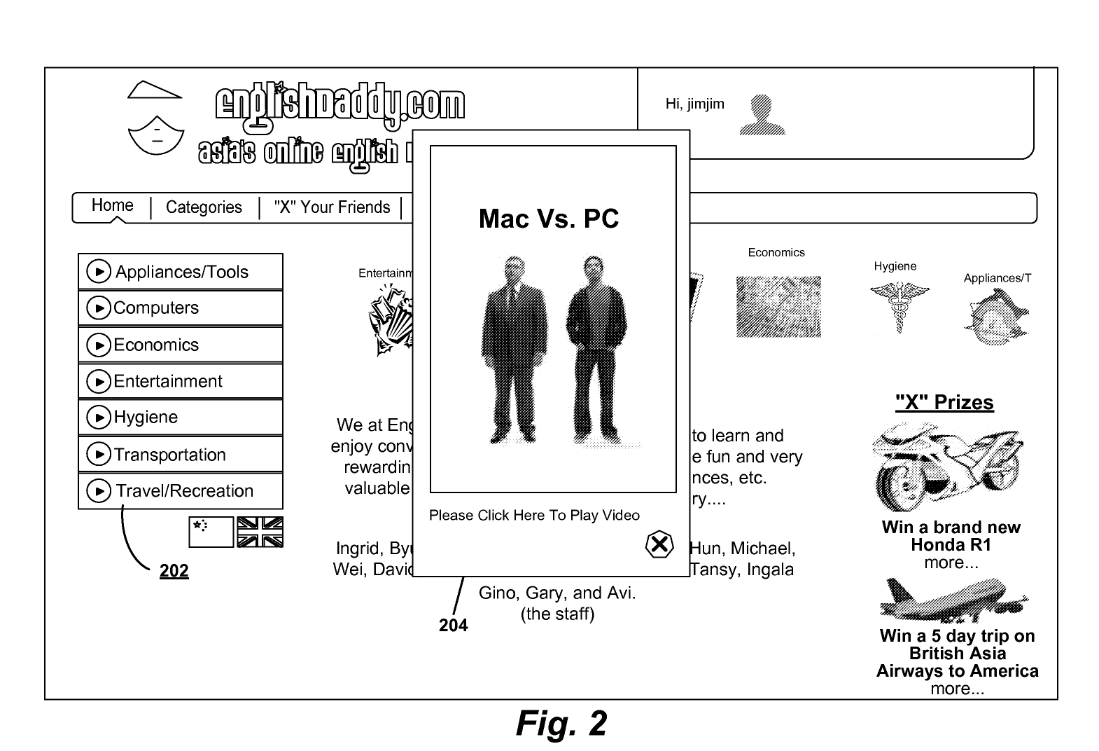

FIG. 2 is a screenshot illustrating a page 200 that may result from a user selecting the icon, in the FIG. 1 screenshot, representing the computer category 102. In the FIG. 2 example, a pop-up window 204 is displayed that indicates a particular advertisement with which the user may intensively interact for learning conversational aspects, in particular, of a second language. In the FIG. 2 example, a well-known “Mac vs PC” advertisement is utilized. This advertisement is well-suited for learning conversational aspects of the language in which it is presented since it includes a dialog between speakers (i.e., one speaker for “Mac” and one speaker for “PC”). One type of advertisement that may be ideal for use with the program is such an advertisement that is dialog-intensive, so that the program user may not only hear the actor's voice, but may also observe body language of the actor. If multiple actors are involved in the dialog, this may also help to contribute to a user learning a conversational style in the second language, particularly since the user may observe not only an actor who is speaking but may also observe an actor who is listening, which affects the user's understanding of the conversational style. In turn, the advertisement is intensively presented to the user, and the advertiser greatly benefits from such exposure as well.

The user may indicate satisfaction with a choice of advertisement by selecting the advertisement (e.g., by clicking in the window 204), and a second language learning interface may be provided that is specific to the selected advertisement. Since the user herself has chosen the advertisement, there is a high probability that the user has interest in the subject of the advertisement. Thus, the value to the advertiser is much higher than for an advertisement that is pushed randomly, based on demographics, or even based on particular known characteristics of the target user. Before proceeding to describe how the user may further interact with user interfaces of the program, we provide some additional description of how the advertising material itself may be obtained for presentation via the learning method. For example, the provider of the program may sell directly to advertisers. In addition, third party sellers may be enlisted as well, such as brokers who have contacts and expertise in particular geographic areas for which it is sought to provide the program.

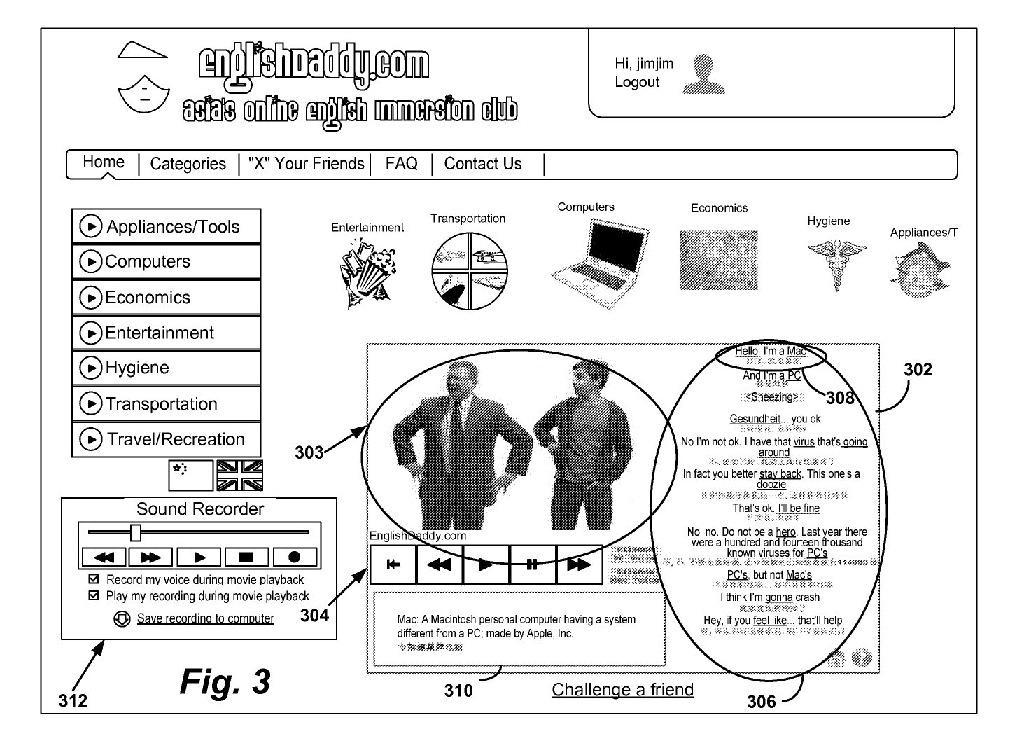

Turning now to FIG. 3, we discuss an example of how the selected advertisement may be presented to a user and how the user may interact with the program relative to the advertisement. In the FIG. 3 example, the advertisement is animatedly displayed in a portion 302 of a user's computer screen. That is, the advertisement display has a moving video portion 303. In addition, audio of the advertisement is correspondingly played (displayed) using the audio playing facility of the user's computer. By “display” of the advertisement, we are referring to the presentation of both video and audio. A portion 304 of the portion 302 is provided with positioning buttons via which the user may modify how the advertisement is displayed, such as to play, fast forward, rewind, pause, and return directly to the beginning or to an earlier portion.

In a portion 306 of the screen, a textual listing of the audio portion of the advertisement is provided. At any particular point while the advertisement is being displayed, the corresponding portion of text of the presently-displayed advertisement portion is highlighted. Thus, for example, as the “Mac vs. PC” advertisement is first displayed, the text 308 is highlighted corresponding to, in English, the audio of “Hello, I'm a Mac.” In addition, the highlighted text includes text corresponding to that same audio in a language that is native to the user. In addition, particular words and/or phrases of the highlighted text may be underlined or otherwise emphasized or indicated. For example, the highlighted text may correspond to slang or other words or phrases deemed to significant to learning the second language conversationally. Based on a user selecting one of the particular words and/or phrases, a definition of the word and/or phrase is provided in a portion 310 of the display. The definition may be particularly useful if the word and/or phrase is slang, such as American slang.

Furthermore, the user may interact with a user interface of the display to selectively inhibit display of the various voices, such as inhibiting display of the audio for “Mac” voice or of the “PC” voice, using the FIG. 3 example. Thus, for example, in use of the program, the user may speak in place of the audio that has been inhibited. Furthermore, the user may interact with the user interface of the display to cause the user's voice to be recorded for automatic evaluation by a facility of the program and/or for later playback. The interface portion 314 is an interface to a sound recording utility, which is provided when a program is being viewed. The sound recording utility may be always visible when a movie/commercial is being viewed. The checkboxes in the interface portion 312 allow the user to either synch her voice with the audio portion of the program, or to just record the user's voice without regard for synching with the program, Thus, for example, the user can dub her voice over one of the voices of the program or provide the voice of the other role in the conversation of the program.

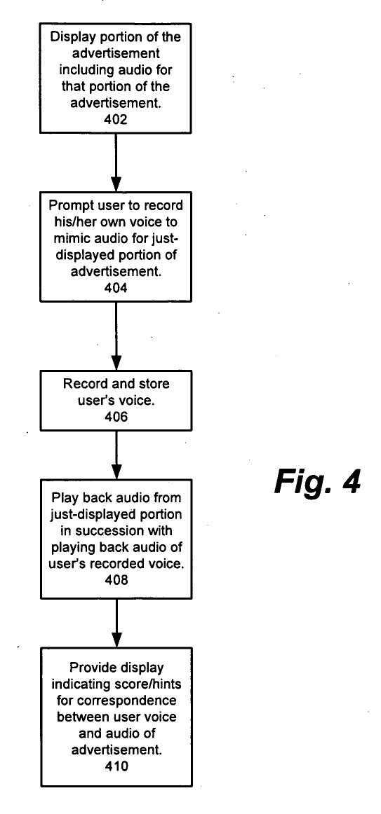

As illustrated in the FIG. 4 flowchart, in one example mode, after causing a portion of the advertisement to be displayed, then the program causes display of a prompt to the user to record his/her own voice, to mimic the audio track of the portion or to provide, as mentioned above, user input in place of audio of the advertisement that has been inhibited. For example, the program may, after recording the user's voice, be caused to play back the mimicked portion and then the user's voice, in succession. In this way, the user can hear how similar or dissimilar her voice is to the voice in the audio track of the advertisement. Furthermore, the recording of the user's voice may be processed in comparison to the audio track of the portion and scoring and/or suggestion may be displayed to the user.

Referring now specifically to FIG. 4, at 402, a portion of the advertisement audio/video is caused to be displayed to the user (such as by the user selecting a “play” button on a user interface or by the user selecting a portion of the displayed text). At 404, the user is prompted to record his/her own voice to mimic the audio of the just-displayed portion of the advertisement. The prompt may be, for example, an audio prompt or a video prompt, or both. For example, the prompt may be displayed in a pop-up window of the user interface. While the user is speaking, captioned text may be provided to more specifically direct what the user is to speak. In another example, voice-over guidance may be provided to the user in place of or in addition to the captioned text.

At 406, the user's voice is recorded and stored. For example, the user may have selected a “record” user interface button to prepare the user's computer to receive input from a microphone into which the user speaks. As another example, the recording may be voice activated, such that the program receives input from the microphone based on the user beginning to speak, with no other action required from the user with respect to a user interface.

At 408, the audio (and which may include the video) of the just-displayed advertisement portion is played back, in succession with playing back the recording of the user's own voice (which may also include the video of the advertisement). This allows the user to hear the difference between the audio of the advertisement versus the audio of the user's own voice. At 410 (which may be in conjunction with 408), a display is provided indicating, to the user, a score, suggestion and/or hints for improving correlation between the audio of the just-displayed advertisement portion and the user's own voice. See, for example, the “Versant for English” program provided by Harcourt Assessment Inc. of Menlo Park, Calif., which is a tool to measure how well the user's voice correlates to the audio of the advertisement.

Having described how the program may operate, we now describe some examples of how the program may be implemented. In one example, a centrally-accessible hub server program interoperates with a complementary client-based program to control how the advertisement is displayed to the user. For example, the hub server may cause the advertisement video/audio to be streamed to a client's computer at the request of the client-based program. The streamed information may include, for example, ancillary material such as the textual listing of the audio portion of the advertisement, dictionary definitions and other information such as that shown on the FIG. 1 to FIG. 3 screen shots. In addition, the streamed information may include, for example, meta-information that may be processed by the client-based program, such as in view of input signals provided to the client-based program as a result of user interaction with the client computer, to control the manner and configuration of display on the client computer.

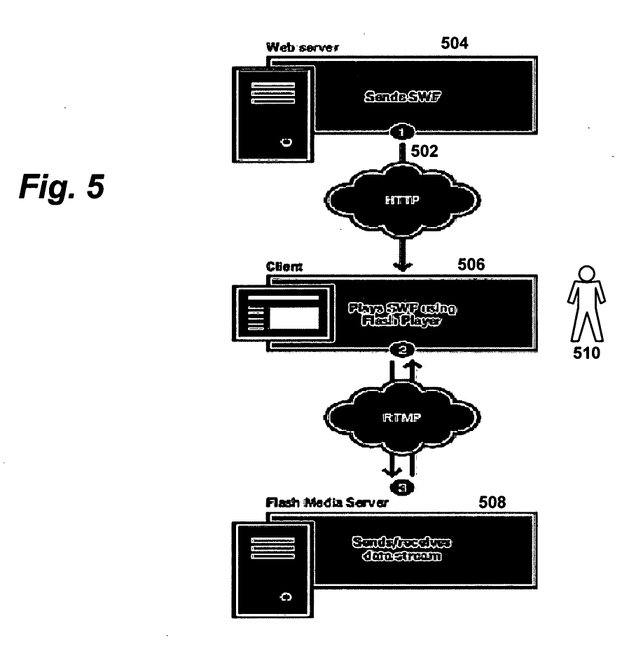

FIG. 5 illustrates an example architecture in which the streamed information 502 is included in a “Shockwave Flash” file (“SWF file”) and is provided from a web server 504, via HTTP (e.g., over a global information network such as the internet), to a client computer 506 executing a “Flash” player (such as provided by Adobe Systems of San Jose, Calif.). For example, the Flash player may be executed by the client computer 506 in a plug-in manner via a browser executing on the client computer. The Flash player executing on the client computer 506 may be in communication with a Media Server 508, such as using a proprietary Adobe RTMP (Real Time Messaging Protocol). The Media Server 508 may be provided by Adobe Systems or by one of various open-source providers. In some examples, the Media Server 508 being in communication with the Flash player executing on the client computer 506 enables particular functions of the Flash player, such as enabling the recording of the voice of the user 510 onto a local drive of the client computer 506. In addition, as will be discussed later, in uses of the program in which two or more users are accessing the advertisements simultaneously from separate client computers (such as to compete with each other with respect to the advertisements and mimicking the audio of the advertisements), the Media Server 508 may operate to coordinate the operation of the Flash players operating on the various client computers such that the users may have a collective experience relative to the advertisement and learning a second language, even while the users may be physically separate and, in fact, may not even know each other.

In one example, a flash media editor tool is used to author the content of the Shockwave Flash file. The authored content may be comprised of a plurality of time-synchronized scenes. That is, each scene may be synchronized to the same time base, such that, at any time, there may be what appears as a seamless switch between the scenes. For example, one scene may correspond to the “Mac” portion of the “Mac vs. PC” advertisement, such that the audio for the “PC” portion of the advertisement is not included in this scene. Another scene may correspond to the “PC” portion of the “Mac vs. PC” advertisement, such that the audio for the “Mac” portion of the advertisement is not included in this scene. Yet another scene may include the audio for both the “Mac” portion of the advertisement and the “PC” portion of the advertisement. These scenes are synchronized to the same time base such that, for example, if what is being displayed to the user is a scene with only the Mac voice, and the user selects a “Play all voices” button on the user interface (see, e.g., item 312 in FIG. 3 then, in response, there is a switch to a different scene in which both the Mac and PC voices are being provided, and the switch is to the other scene at precisely the same point in time, so that the switch appears to be seamless to the user.

This seamless scene switching may be accomplished through the incorporation of reusable objects into the definitions of the scenes, wherein each object is synchronized to a global time base. Thus, for example, the video portion of the advertisement may be incorporated as one object; the textual version of what the PC actor is saying may be incorporated as another object; the textual version of what the Mac actor is saying may be incorporated as another object; the highlighting for the Mac portion of the text may be incorporated as another object; and the highlighting for the PC version of the text may be incorporated as yet another object. Similarly, the audio portions of the advertisements may be incorporated as separate objects, one for “Mac” and one for “PC.”

In this way, each scene may draw on the appropriate objects as appropriate to make up that scene. For example, the scene that corresponds to “Mac only” being selected may incorporate the object that is the full video for the advertisement but also incorporate the object that is only the audio of what the Mac actor is saying. In addition, the highlighting of this scene may include highlighting only for the Mac portion of the text. An indication that the user has selected “play all voices” may cause a switch to a different scene, where the different scene also incorporates the objects incorporated in the “Mac only” scene, but also incorporates the object for the audio of what the PC actor is saying and the object for the highlighting of the PC portion of the text.

Yet further, even the text may be represented by various objects. For example, if the program has been selected for a user who is a native speaker of Chinese, then the text may have both English and Chinese (one object). In fact, the English text may be represented by one object and the Chinese text represented by another object, so that the object of the English text may be used in scenes for Chinese native speakers and for native speakers of other languages, such as Japanese or Korean (with particular objects for the Japanese text or the Korean text).

Furthermore, an object can be comprised of sub-objects, such that an object can be built modularly. For example, a dictionary box such as the box 310 in FIG. 3 can be accomplished using a “movie within a movie,” being comprised of its own scenes (and, for example, suspending the time frame of the main movie while the time frame of the sub-movie takes over). The scenes can intercommunicate in order to synchronize with each other. For example, the user selecting a phrase in the text may cause display of the “dictionary movie” while the main “movie” is paused. The user selecting to exit the dictionary box may be cause control to be passed back to the main movie, at the point at which the main movie was paused.

In one example, the scenes are scripted using Action Script (such as Action Script, version 2.0), which is a scripting language provided for the Adobe Flash authoring tool. Action Script, which is well-known, provides for attaching “actions” to portions of the Flash display. Activation of a button or other user interface item by a user (e.g., by clicking using a mouse input device) typically causes navigation within a scene or into another scene. Furthermore, facility is provided to author and incorporate objects, as discussed above.

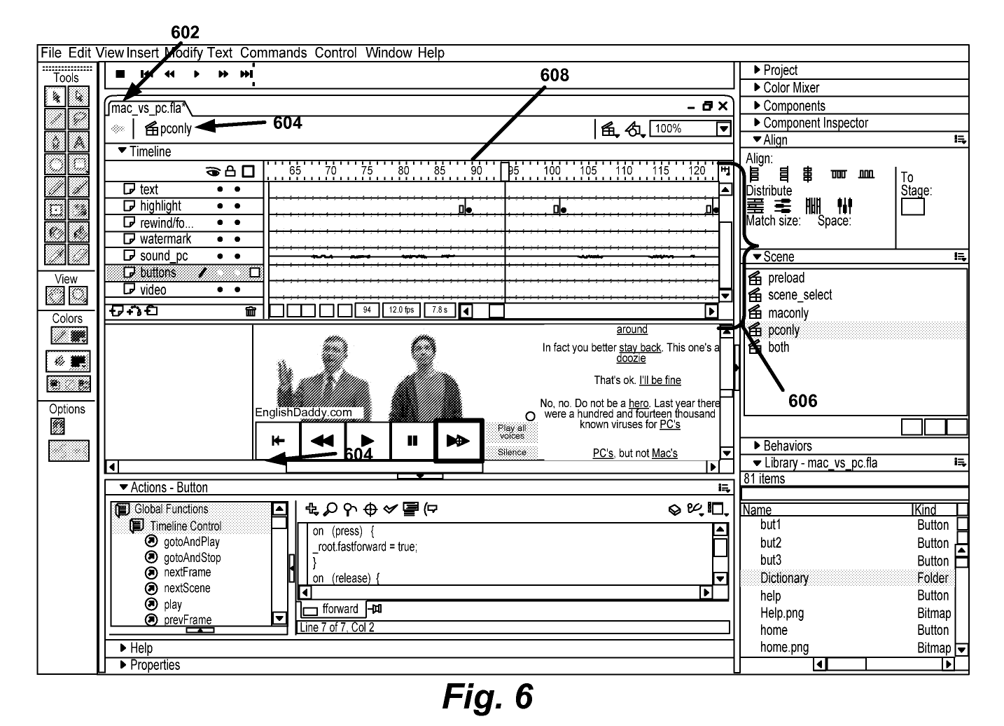

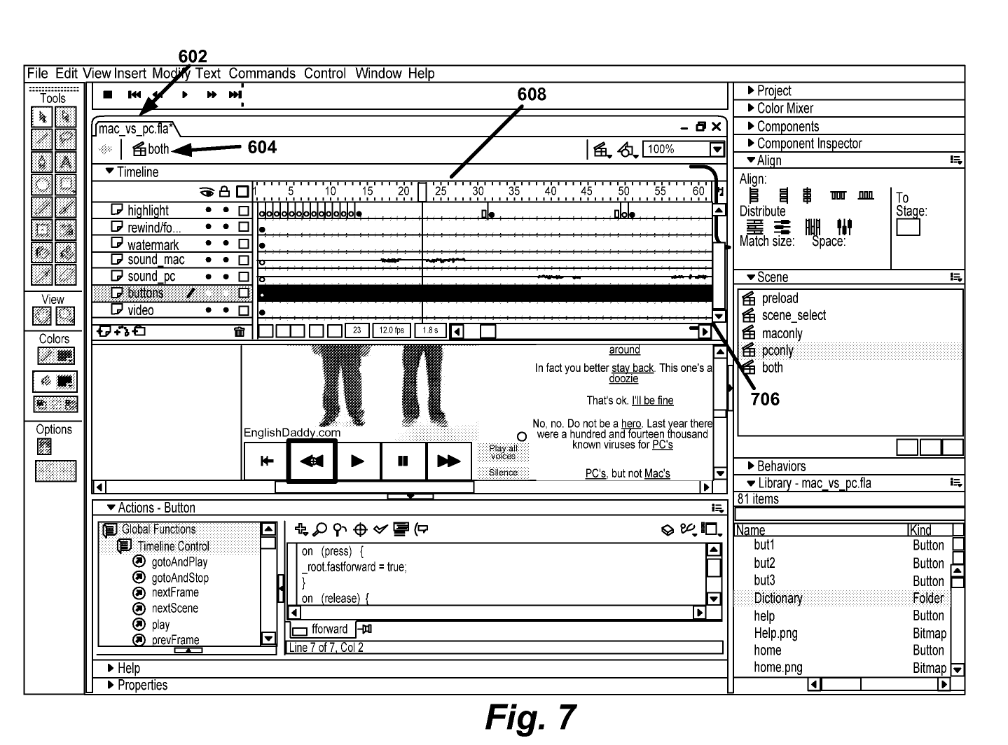

FIGS. 6 and 7 are screen shots of a Flash editor program, which serves to illustrate the scene/object nature of program organization in one example. FIG. 6 illustrates, for a SWF file to implement the “Mac vs. PC” example 602, a scene that represents the “PC only” portion 604. The time synchronized portions 606 are comprised of various objects such as, for example: “underline”; “dictionary”; “home”, etc. These objects may run (i.e., be processed/displayed) simultaneously, according to the timeline 608. FIG. 7 illustrates, for the SWF file to implement the “Mac vs. PC” example 602, a scene that represents the “PC” and “Mac” portions together (indicated as “both” 704).

Many of the objects of which the time synchronized portions 706 are comprised are the same as the objects of which the time synchronized portions 606 are comprised in the “PC only” portion 604 and run according to the same timeline 608. In this way when, in execution of the program, a switch is made between scenes (such as, for example, as a result of user action relative to the user interface, such as selecting the “Play all voices” button 312, in FIG. 3), the switch from one scene to another scene appears seamless. That is, when a switch is made from one scene to another scene, the time synchronization is maintained. Therefore, for example, the objects that are common to each scene appear, in the switch, to be played continuously without interruption. It is noted that, for example, the “sound_mac” object is not in the scene illustrated by the FIG. 6 screenshot, but the “sound_mac” object is in the scene illustrated by the FIG. 7 screenshot.

More generally, an object that is incorporated into the first scene but is not incorporated into the scene to which the switch is made appears to just stop playing at the switch, whereas an object that is not incorporated into the first scene but is incorporated into the scene to which the switch is made appears to just begin playing at the switch. The facility to use objects in this manner, compiling them into scenes, makes it efficient to decompose and subsequently re-compose advertisements and supporting material for use in teaching English. In addition, if it is desired or required to modify a portion of the presentation, that portion can be modified as part of an object, and all scenes employing that object are automatically modified. For example, it may be desirable to provide subtext in the portion in a different language (e.g., Korean rather than Chinese). An object including the English and Korean language may be substituted for the object including the English and Chinese language. For that matter, the subtext (e.g., Korean or Chinese text) may be provided as a separate object unto itself. The alternate text may be provided as objects in different scenes; for example, one scene may include English with Korean subtext and another scene may include English with Chinese subtext, and a user selection may result in a seamless switching between those scenes.

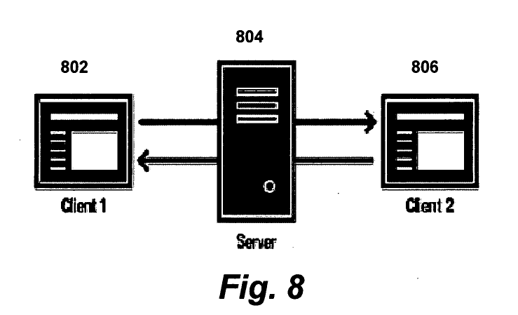

In some examples, a user of the program may compete with one or more other users of the program, even if those users are at different physical locations. Thus, for example, as shown in FIG. 8, a first user (at a first client computer 802) and a second user (at a second client computer 804) may interact with the same SWF (such as provided from the web server 504 (FIG. 5). A media server 806, such as a Flash media server, operates as a communication and control channel between the two users. Thus, for example, the two users may simultaneously interact with the same SWF file, each generating a “score” regarding the recording of the user's own voice versus the audio of the advertisement. The media server 806 may then operate to communicate each score to the respective competitor user, thus allowing the competitors to see which user has achieved the highest score.

While the examples illustrate providing the program via a network such as the internet, the program may be provided in other ways, such as by a local area network, a private network, a cellular network and/or a television distribution network.

Advantages of the invention are numerous. Different embodiments or implementations may yield one or more of the following advantages. One advantage of the invention is that a second language can be taught in an interactive manner, while providing a facility in which users (potential consumers) intensively interact with advertising material. Due to this intensive interaction, the value of the advertising exposure is greatly increased, which greatly enhances the possible revenue to be gained from the advertisers. Furthermore, the advertising revenue can be used to cover operating expenses associated with providing the advertising/interaction infrastructure, such that the facility may be provided without cost to the users, enhancing the appeal to the users. More broadly, in accordance with the aspects of the invention, users may intensively interact with material that provides immersion with conversational aspects of a language.

The many features and advantages of the invention are apparent from the written description and, thus, it is intended by the appended claims to cover all such features and advantages of the invention. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

1. An advertisement delivery method using an immersion method of teaching conversational speech to a user, comprising:
displaying, to the user, portions of video and audio of a program that is an advertisement, including displaying video and audio of a first portion of a conversation by a first actor and video of a second portion of the conversation by a second actor but not audio of the second portion of the conversation, while causing a textual indication of the audio of the second portion of the conversation to be displayed to the user;
recording the voice of the user attempting to speak the audio of the second portion of the conversation synchronously with the display of the textual indication of the audio of the second portion of the conversation; and
playing back the conversation, including playing back the audio of the first portion of the conversation and the recording of the user's voice attempting to speak the audio of the second portion of the conversation,
whereby the user is immersed in the advertisement by practicing a role of the conversation present in the advertisement.

2. The advertisement delivery method of claim 1, further comprising:
evaluating the user with respect to a correspondence of the recorded voice of the user relative to the audio of the second portion of the conversation, which the user is attempting to speak; and
providing the user an indication of the evaluating.

3. The advertisement delivery method of claim 1, further comprising:
repeating the displaying, recording and playing steps based on user input provided from the user via a user interface.

4. The advertisement delivery method of claim 1, wherein:
the method further comprising, by a provider of the method, collecting compensation based on employing the advertisement in the method.

5. The advertisement delivery method of claim 4, wherein:
the user is a first user of a plurality of users;
collecting information regarding the displaying, recording and playing relative to the plurality of users; and
providing the information to a third party that is not one of the plurality of users.

6. The advertisement delivery method of claim 1, further comprising:
accessing the portions of video and audio of the program via a network.

7. The advertisement delivery method of claim 6, wherein the network is one of a group consisting of:
a global information network, a local area network, a private wide area network, and a television distribution network.

8. The advertisement delivery method of claim 6, wherein:
the audio of the program includes voices from at least two different actors, corresponding to the first and second portions of the conversation, respectively; and
the method further comprises selecting the voice of one or more of the at least two different actors based on user input provided by the user via a user interface of a device connected to the network.

9. The advertisement delivery method of claim 1, further comprising:
prompting the user for information indicative of comprehension of the program by the user.

10. The advertisement delivery method of claim 9, further comprising:
providing, to a provider of the program, the information indicative of comprehension of the program by the user.

11. The advertisement delivery method of claim 1, further comprising:
carrying out the displaying, recording and playing steps with respect to a second user; and
evaluating each of the first user and the second user with respect to a correspondence of the recorded voice of that user relative to the audio of that portion of the conversation which that user is attempting to speak.

12. A system configured for advertisement delivery by teaching conversational speech to a user, the system configured to:
display, to the user, portions of video and audio of a program that is an advertisement, including to display video and audio of a first portion of a conversation by a first actor and video of a second portion of the conversation by a second actor but not audio of the second portion of the conversation, while causing a textual indication of the audio of the second portion of the conversation to be displayed to the user;
record the voice of the user attempting to speak the audio of the second portion of the conversation synchronously with the display of the textual indication of the audio of the second portion of the conversation; and
play back the conversation, including playing back the audio of the first portion of the conversation and the recording of the user's voice attempting to speak the audio of the second portion of the conversation,
whereby the user is immersed in the advertisement by practicing a role of the conversation present in the advertisement.

13. The advertisement delivery system of claim 12, further configured to:
evaluate the user with respect to a correspondence of the recorded voice of the user relative to the audio of the second portion of the conversation, which the user is attempting to speak; and
provide the user an indication of the evaluating.

14. The advertisement delivery system of claim 13, further configured to:
repeat the displaying, recording and playing based on user input provided from the user via a user interface.

15. The advertisement delivery system of claim 12, wherein:
the system is further configured to, by a provider of the system, collect compensation based on employing the advertisement in the method.

16. The advertisement delivery system of claim 15, wherein:
the user is a first user of a plurality of users;
the system is further configured to
collect information regarding the displaying, recording and playing relative to the plurality of users; and
provide the information to a third party that is not one of the plurality of users.

17. The advertisement delivery system of claim 12, further configured to:
access the portions of video and audio of the program via a network.

18. The advertisement delivery system of claim 17, wherein the network is one of a group consisting of:
a global information network, a local area network, a private wide area network, and a television distribution network.

19. The advertisement delivery system of claim 17, wherein:
the audio of the program includes voices from at least two different actors, corresponding to the first and second portions of the conversation, respectively; and
the system is further configured to select the voice of one or more of the at least two different actors based on user input provided by the user via a user interface of a device connected to the network.

20. The advertisement delivery system of claim 12, further configured to:
prompt the user for information indicative of comprehension of the program by the user.

21. The advertisement delivery system of claim 20, further configured to:
provide, to a provider of the program, the information indicative of comprehension of the program by the user.

22. The system of claim 12, further configured to:
carry out the displaying, recording and playing with respect to a second user; and
evaluate each of the first user and the second user with respect to a correspondence of the recorded voice of that user relative to the audio of that portion of the conversation which that user is attempting to speak.

23. A method of immersing a user of a device into an advertisement, comprising:
causing the device to display the advertisement to the user; and
operating the device to display the advertisement to the user to facilitate the user playing a role in the advertisement.

24. The method of claim 23, wherein:
operating the device to facilitate the user playing a role in the advertisement includes muting the audio of an actor's voice in the advertisement and displaying, to the user, text corresponding to the muted audio.

25. The method of claim 24, further comprising:
recording the user's voice while the audio of the actor in the advertisement is muted.

26. The method of claim 25, further comprising:
causing the advertisement to be played with the recorded user's voice being played back in place of the voice of actor's voice, the audio of which was muted.

27. The advertisement delivery method of claim 1, further comprising:
initially displaying, to the user, the portions of the video and audio of the program that is the advertisement, including displaying the video and audio of the first portion of the conversation and the video and audio of the second portion of the conversation.

28. The advertisement delivery system of claim 12, the further comprising:
initially displaying, to the user, the portions of the video and audio of the program that is the advertisement, including displaying the video and audio of the first portion of the conversation and the video and audio of the second portion of the conversation.
